(19) United States
(12) Patent Application Publication
(10) Pub. No.: US 2021/0056622 A1
(43) Pub. Date: Feb. 25, 2021

(54) OPTIMAL FEATURE SUBSET SELECTION METHOD IN CREDIT SCORING BASED ON INFORMEDNESS COEFFICIENT

(71) Applicant: DALIAN UNIVERSITY OF TECHNOLOGY, Dalian, Liaoning (CN)

(72) Inventors: Guotai CHI, Dalian, Liaoning (CN); Zhipeng ZHANG, Dalian, Liaoning (CN); Ying ZHOU, Dalian, Liaoning (CN)

(21) Appl. No.: 16/969,476

(22) PCT Filed: May 22, 2018
(86) PCT No.: PCT/CN2018/087773

§ 371 Date: Aug. 12, 2020

(51) Int. Cl. G06Q 40/02; G06Q 10/10; G06F 17/15

(52) U.S. Cl. CPC G06Q 40/025; G06F 17/15; G06Q 10/10

(57) ABSTRACT

The present invention provides an optimal feature subset selection method in credit scoring based on Informedness coefficient. The present invention aims to solve the problem that the existing credit scoring system cannot ensure the strongest overall default identification ability and does not consider the correlation among features when selecting a set of features. With the maximum default identification ability of the Informedness coefficient of the credit score as the standard for optimizing a feature subset, with the decision variable that whether the feature is selected into a feature subset, with the maximum default identification ability of the Informedness coefficient as the objective function, and with the constraint condition that features reflecting information redundancy cannot be simultaneously selected to establish a 0-1 programming model, the optimal feature subset in credit scoring is selected.

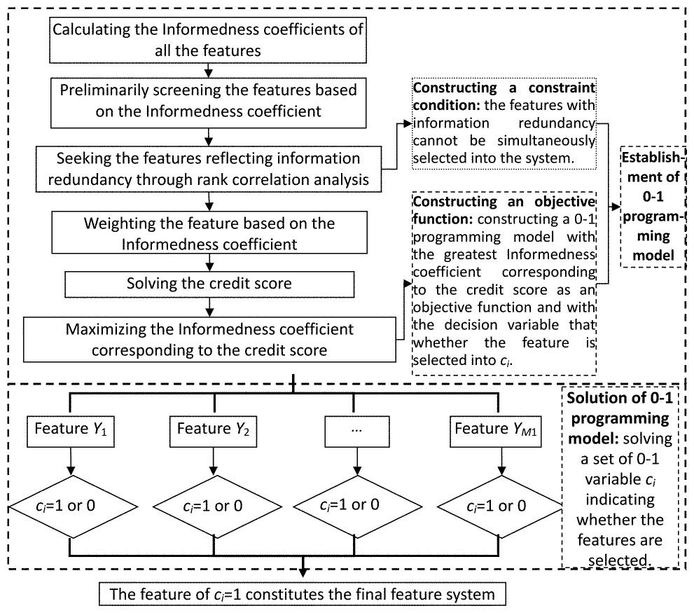

### TECHNICAL FIELD

The present invention provides an optimal feature subset selection method for a credit scoring system, particularly relates to a method for selecting an optimal feature subset in credit scoring with the maximum default identification ability of the Informedness coefficient of the credit score as the standard for optimizing a feature subset, with the decision variable that whether the feature is selected into a feature subset, with the maximum default identification ability of the Informedness coefficient as the objective function, and with the constraint condition that features reflecting information redundancy cannot be simultaneously selected as the constraint condition to establish a 0-1 programming model, and belongs to the technical field of credit service.

### BACKGROUND

Credit is a lending activity on the condition of repaying principal and interest. Credit scoring aims to evaluate the credit level and the corresponding default probability of a customer through the value and status of a credit scoring feature. The optimal feature subset selection in credit scoring is a process of selecting a feature subset with the highest default identification accuracy from a plurality of credit scoring feature subsets.

Each feature has two statuses: selected and unselected, so the larger the number of feature subsets is, the more difficult the optimal subset is. Because each feature has two conditions: selected into a feature subset and not selected into a feature subset, and whether each feature is selected does not affect the selection of other features, the number of subsets is the continued multiplication of the possible conditions (two) of selection of each feature, and n features have 2×2× . . . ×2=2ⁿ subsets.

The existing research on the selection of credit scoring features includes two types: one is on the selection of credit scoring features based on individual features, and the other is the selection of credit scoring features based on the feature subset.

In terms of a credit scoring feature system selected based on individual features, Guotai Chi (2017) screens individual features which can identify the default status through rank sum test, removes features reflecting information redundancy through rank correlation analysis, and finally establishes a small business credit scoring feature system covering 5C principles of morality, capital, ability, business environment and guarantee on the basis of an initial feature set including repayment ability and repayment willingness. Wang Di (2016) selects individual features to constitute a feature system based on various feature selection methods such as F-score, information gain ratio and Pearson correlation coefficient.

The existing research on the credit scoring feature system selected on the basis of the feature subset mainly includes a sequential selection method, a Lasso regression method and a stepwise regression method. For example, Sun Jie et al. (2011) uses the sequential floating forward selection algorithm to make the finally selected feature set the most similar to the information content of the overall feature set. Choi et al. (2015) screens a feature set containing discrete features and continuity features and establishes a feature system for a credit scoring model based on a hybrid Lasso method. Yiwen Chien et al. (2001) selects features such as income and marital status that affect credit card defaults through stepwise regression.

The existing research has the following problems when constructing the feature system: on one hand, the existing research constructs the feature system only from the perspective that whether individual features have the default identification ability without considering the phenomenon that when the default identification ability of individual features is strong, the overall default identification ability of the feature system is not necessarily strong. On the other hand, even if a set of credit scoring features is selected, the sequential selection algorithm, the Lasso algorithm and the stepwise regression method do not consider the correlation between the features, which most likely selects features reflecting the same information into the feature system, resulting in redundancy of the reflected information of the feature system.

The present invention finds the feature system with the greatest Informedness coefficient corresponding to the feature system, that is, with the strongest default identification ability, through 0-1 programming and ensures the overall default identification ability of the feature system, as well as removes features reflecting information redundancy and avoids the information redundancy of the feature system by constructing the constraint condition that at most only one of a set of features reflecting information redundancy is selected into a feature subset in 0-1 programming when maximizing the Informedness coefficient of the feature subset.

### SUMMARY

The purpose of the present invention is to provide a method for optimizing a feature subset in credit scoring to maximize the Informedness coefficient of the default identification ability of the credit score.

The technical solution of the present invention is:

With the idea that the higher the determination accuracy for the default status of a customer is, the greater the Informedness coefficient corresponding to the credit score is, with the greatest Informedness coefficient IN of the credit score as the objective function, and with the constraint condition that at most only one of a set of features reflecting information redundancy is selected into a feature subset, a 0-1 programming model is established to deduce a set of 0-1 variables cᵢ indicating whether the feature is selected and the corresponding feature subset so as to ensure that the selected feature system has the highest default identification accuracy and avoid the information redundancy of the feature system.

An optimal feature subset selection method in credit scoring based on Informedness coefficient, comprises nine steps, wherein steps 1-2 are to load and preprocess data, steps 3-7 are to determine the objective function of 0-1 programming, step 8 is to determine the constraint condition of 0-1 programming, step 9 is to solve the 0-1 programming model and determine the optimal feature subset, and the specific steps are as follows:

Step 1: loading data

Loading the data of M₀ initial credit scoring features of N customers and the data of default statuses of the N customers into an Excel file, wherein default=1 and non-default=0;

Step 2: preprocessing the data

Standardizing the data of the mass-selection credit scoring features to eliminate the influence of feature dimension;

Several methods are provided to standardize the data of the feature, and one is the Max-Min.

Step 3: calculating the default identification ability inᵢ of an individual mass-selection credit scoring feature

Measuring the default identification ability of the feature by the Informedness coefficient inᵢ of the feature; the greater the Informedness coefficient of the feature is, the more the actual default customers are determined to be default, and meanwhile, the more the actual non-default customers are determined to be non-default, i.e., the feature has the default identification ability; and the formula of the Informedness coefficient of the feature i is as follows:

$${in}_{i} = \frac{a}{a + b} + \frac{d}{c + d} - 1 \qquad ( 1 )$$

In formula (1), a is the number of customers which are in actual default and are determined to be default; b is the number of customers which are in actual default but are determined to be non-default by mistake; c is the number of customers which are in actual non-default but are determined to be default by mistake; and d is the number of customers which are in actual non-default and are determined non-default;

a, b, c and d in formula (1) are obtained through the comparison result of the determined default status Dⱼ and the actual default status Tⱼ; the determined default status is obtained according to the cut-off point xᵢ^{c}; and when the value xᵢⱼ of the feature i of the customer j is greater than the cut-off point xᵢ^{c} of the feature i, the customer is determined to be non-default; otherwise, the customer is determined to be default, that is:

$$\{ \begin{matrix}{x}_{ij} > {x}_{i}^{c} , & {D}_{j} = 0 \\ {x}_{ij} \leq {x}_{i}^{c} , & {D}_{j} = 1\end{matrix} \qquad ( 2 )$$

Taking the values of the features i of all the customers respectively as cut-off points to determine the default statuses of all the customers; and setting the cut-off point of the greatest Informedness coefficient inᵢ corresponding to the feature i to the cut-off point of the feature i, and the corresponding greatest Informedness coefficient is the Informedness coefficient of the feature i;

Step 4: removing the feature which has the Informedness coefficient inᵢ≤0 and cannot identify the default status, and the number of the remaining features becomes M₁;
Step 5: introducing the decision variable cᵢ, and giving a weight wᵢ to the credit scoring feature

Adopting the Informedness coefficient inᵢ of the feature to weight the credit scoring feature, and ensuring that the greater the Informedness coefficient is, the larger the weight corresponding to the feature with the stronger default identification ability is, that is:

$${w}_{i} = ( {in}_{i} \times {c}_{i} ) \text{/} {\sum }_{i = 1}^{{M}_{1}} ( {in}_{i} \times {c}_{i} ) \qquad ( 3 )$$

In formula (3), wᵢ is the weight of the i^{th} feature; cᵢ indicates whether the i^{th} feature is selected into the feature system, if yes, cᵢ=1, and if not, cᵢ=0; cᵢ is also the decision variable of the 0-1 programming model of the optimal feature subset; and M₁ is the number of features to be weighted;

Step 6: constructing a functional relation between the credit score Sⱼ of the customer and the weight wᵢ of the feature

Adopting the linear weighting formula to construct the expression of the credit score Sⱼ of the customer, that is:

$${S}_{j} = {\sum }_{i = 1}^{{M}_{1}} {w}_{i} \times {x}_{ij} \qquad ( 4 )$$

In formula (4), wᵢ is the weight of the i^{th} feature, and x^{ij} is the value of the i^{th} customer under the i^{th} feature;

Step 7: constructing the objective function of the 0-1 programming model with the greatest Informedness coefficient IN of the credit score

Replacing the value of the feature in step 3 with the credit score to obtain the Informedness coefficient corresponding to the credit score, and recording as IN; and using the greatest Informedness coefficient IN of the credit score as the objective function, as shown in formula (5):

$$obj \text{:} max IN = \frac{a}{a + b} + \frac{d}{c + d} - 1 \qquad ( 5 )$$

In formula (5), the Informedness coefficient IN corresponding to the credit score is obtained according to the comparative analysis of a and b, i.e. according to the comparison of the determined default status Dⱼ and the actual default status Tⱼ of all the customers, i.e. IN=f (Dⱼ,Tⱼ); and the comparison of default statuses is obtained according to the relationship between the credit score Sⱼ of the customer and the cut-off point S_{c} of the credit score, i.e. IN=f[g(Sⱼ, S_{c}),Tⱼ], so the Informedness coefficient IN corresponding to the credit score is related to the credit score of the customer;

The credit score Sⱼ of the customer is the linear weighting of the value xᵢⱼ of the feature of the customer and the weight wᵢ of the feature, as shown in formula (4), i.e. IN=f[h(xᵢⱼ,wᵢ),Tⱼ]; the weight wᵢ is also function of the variable cᵢ of the 0-1 programming model and the Informedness coefficient inᵢ of the feature, as shown in formula (3), i.e. IN=f{h[xᵢⱼ,q(cᵢ,inᵢ)],Tⱼ}; and therefore the Informedness coefficient IN corresponding to the credit score is the function of the decision variable cᵢ;

If the selected feature is different, that is, cᵢ is different, the weight wᵢ of the feature obtained through step 5 is different, the credit score Sⱼ obtained through step 6 is different, and the Informedness coefficient IN corresponding to the credit score is also different; and with the greatest Informedness coefficient IN of the credit score as the objective function and with the decision variable that whether the feature is selected into cᵢ, 0-1 programming is constructed to select one feature subset with the strongest default identification ability as the feature system;

Step 8: constructing the constraint conditions of the 0-1 programming model

Determining the features reflecting information redundancy through rank correlation analysis; if the rank correlation coefficient of a pair of features is greater than or equal to 0.8, the pair of features reflects information redundancy; and for each pair of repeated features, an inequality constraint condition is established to ensure that at most only one of a set of features reflecting information redundancy is selected into the final system, as shown in formula (6):

cₖ+cₗ≤1 (6)

wherein cₖ and cₗ are 0-1 variables indicating whether the pair of features k and l reflecting information redundancy is selected into the final feature system; and the number of pairs of features reflecting information redundancy is equal to the number of constraint equations (6);

Several methods are provided to determine features reflecting information redundancy, and one is the rank correlation method;

Step 9: solving the 0-1 programming model and determining the optimal feature subset

With formula (5) as the objective function and formula (6) as the constraint condition, constructing the 0-1 programming model, and solving the model to obtain the feature subset with the greatest Informedness coefficient IN of the credit score and the corresponding default identification ability of the greatest Informedness coefficient;

Among all the feature subsets selected in the above 9 steps, the subset of features with the greatest Informedness coefficient of the default identification ability of the credit score is the optimal feature subset to ensure that the final feature subset can distinguish default customers and non-default customers to the maximum extent.

The present invention has the following beneficial effects:

1. The present invention provides a method for optimizing a feature subset in credit scoring based on the maximum default identification ability of Informedness coefficient, which can ensure that the overall default identification ability of the credit scoring system is maximum and provide a new method and a new idea for constructing the credit scoring feature system.

2. How to find the feature subset with the maximum default identification ability from all the feature subsets is a problem to be urgently solved in construction of the credit scoring feature system. The present invention solves the above problem with the idea of establishing a 0-1 programming model and selecting the subset of features with the greatest Informedness coefficient of the credit score to form a feature system with the maximum default identification ability of Informedness coefficient of credit score as the objective function and with the constraint condition that features reflecting information redundancy cannot be simultaneously selected.

3. The present invention provides a decision basis for banks, credit scoring institutions, credit agencies, insurance companies developing credit default business and other institutions to conduct credit scoring, and provides investment reference for investors purchasing enterprise bonds and lenders of peer-to-peer (P2P) loan.

### DESCRIPTION OF DRAWING

The sole FIGURE is a flow chart of a method for optimizing a feature subset in credit scoring based on the maximum default identification ability of the Informedness coefficient.

### DETAILED DESCRIPTION

Specific embodiments of the present invention are further described below in combination with accompanying drawings and the technical solution.

The work flow of the method for optimizing a feature subset in credit scoring based on the maximum default identification ability of the Informedness coefficient of the present invention is as follows.

With the idea that the higher the determination accuracy for the default status of a customer is, the greater the Informedness coefficient of the credit score is, the default identification ability of the credit score is measured by using the Informedness coefficient. Based on the 0-1 programming model, with the decision variable that whether the feature is selected, with the maximum default identification ability of the Informedness coefficient as the objective function, and with the constraint condition that features reflecting information redundancy cannot be simultaneously selected to establish a programming model, the subset of features with the greatest Informedness coefficient of the credit score is selected to form a feature system.

The solution of the present invention has the following steps:

The steps of the solution of the present invention are described with the data of 1451 small industrial business loans of a commercial bank in China in the past 20 years as an empirical sample.

Step 1: loading data

Loading the source data of all the N=1451 samples, M₀=81 mass-selection credit scoring features and default status (default=1, non-default=0) features into an Excel file.

The first 81 features in column c of Table 1 are mass-selection observable features. Column b of Table 1 is the criterion layer corresponding to a feature, and column d of Table 1 is the type of the feature. The first 81 rows in columns 1-1451 of Table 1 are the raw values of credit scoring features, and row 82 is the value of a default status.

Step 2: preprocessing the data

Standardizing the raw data of the mass-selection credit scoring features in the first 81 rows in columns 1-1451 of Table 1 by standardization methods such as Max-Min to eliminate the influence of feature dimension.

Several methods are provided to standardize the data of the feature, and one is the Max-Min.

The first 81 rows in columns 1452-2902 of Table 1 are the standardized values of the 81 features.

TABLE 1
Raw Data and Standardized Data of 81 Mass-Selection Credit Scoring Features

| | | | | Raw Data νᵢⱼ of Features | | | Standardized Results | | | (e) | | (g) |
|---|---|---|---|---|---|---|---|---|---|---|---|---|
| | | | | of 1451 Customers | | | xᵢⱼ of 1451 Customers | | | In- | | 2^{nd} |
| | (b) | | (d) | 1 | | 1451 | 1452 | | 2902 | formedness | | Number |
| (a) | Criterion | (c) | Feature | Custom- | | Custom- | Custom- | | Custom- | Coefficient | (f) 0-1 | Y of |
| S/N | Layer | Feature | Type | er 1 | . . . | er 1451 | er 1 | . . . | er 1451 | inᵢ | Variable cᵢ | Feature |
| X₁ | Internal | Asset-Liability | Negative | 0.33 | . . . | 0.6 | 0.657 | . . . | 0.369 | 0.330 | 1 | Y₁ |
| | Finance | Ratio | | | | | | | | | | |
| X₂ | Factors of | Net Cash Flow | Positive | 1.17 | . . . | 0.14 | 0.628 | . . . | 0.496 | 0.428 | 1 | Y₂ |
| | Enterprise | Ratio of | | | | | | | | | | |
| | | Current | | | | | | | | | | |
| | | Liabilities from | | | | | | | | | | |
| | | Operating | | | | | | | | | | |
| | | Activities | | | | | | | | | | |
| . . . | | . . . | . . . | . . . | . . . | . . . | . . . | . . . | . . . | . . . | . . . | . . . |
| X₄₈ | | Retained | Positive | 0.52 | . . . | 0.55 | 0.513 | . . . | 0.5133 | 0.310 | 0 | Y₄₈ |
| | | Earnings | | | | | | | | | | |
| | | Growth Rate | | | | | | | | | | |
| . . . | . . . | . . . | . . . | . . . | . . . | . . . | . . . | . . . | . . . | . . . | . . . | . . . |
| X₆₄ | Basic | Education | Quali- | College | . . . | Bachelor | 0.9 | . . . | 1 | 0.252 | 0 | Y₆₃ |
| | Information | | tative | Degree | | Degree | | | | | | |
| . . . | of Legal | . . . | . . . | . . . | . . . | . . . | . . . | . . . | . . . | . . . | . . . | . . . |
| X₇₁ | Represen- | Age | Range | 35 | | 38 | 1 | | 1 | 0 | Deleted in | — |
| | tative | | | | | | | | | | Preliminary | |
| | | | | | | | | | | | Screening | |
| . . . | . . . | . . . | . . . | . . . | . . . | . . . | . . . | . . . | . . . | . . . | . . . | . . . |
| X₇₄ | | Time Served in | Quali- | 3 years | . . . | 4 years | 0.4 | . . . | 0.4 | 0.288 | 0 | Y₇₀ |
| | | This Position | tative | | | | | | | | | |
| . . . | . . . | . . . | . . . | . . . | . . . | . . . | . . . | . . . | . . . | . . . | . . . | . . . |
| X₈₁ | Factor of | Score of | Quali- | General | . . . | Other | 0.35 | . . . | 0.569 | 0.535 | 1 | Y₇₇ |
| | Mortgage | Mortgage and | tative | Mortgage | | Enterprise | | | | | | |
| | and Pledge | Pledge | | of Factory | | Guarantees | | | | | | |
| | Guarantee | | | Building | | and Natural | | | | | | |
| | | | | | | Person | | | | | | |
| | | | | | | Guarantee | | | | | | |

| | | | | | | | | | | |
|---|---|---|---|---|---|---|---|---|---|---|
| 82 | Default Identifier Tᵢ | Non-default | . . . | Non-default | 0 | . . . | 0 | — | — | — |

Step 3: calculating the default identification ability inᵢ of an individual mass-selection credit scoring feature

Measuring the default identification ability of the feature by the Informedness coefficient inᵢ of the feature; the greater the Informedness coefficient of the feature is, the more the actual default customers are determined to be default, and meanwhile, the more the actual non-default customers are determined to be non-default, i.e., the feature has one feature with the default identification ability. The formula of the Informedness coefficient of the feature xᵢ is as follows:

$$in = \frac{a}{a + b} + \frac{d}{c + d} - 1 \qquad ( 1 )$$

In formula (1), a is the number of customers which are in actual default and are determined to be default; b is the number of customers which are in actual default but are determined to be non-default by mistake; c is the number of customers which are in actual non-default but are determined to be default by mistake; and d is the number of customers which are in actual non-default and are determined to be non-default.

The above a, b, c and d are obtained through the comparison result of the determined default status Dⱼ and the actual default status Tⱼ. The determined default status is obtained according to the cut-off point xᵢ^{c}. When the value xᵢⱼ of the feature i of the customer j is greater than the cut-off point xᵢ^{c} of the feature i, the customer is determined to be non-default; otherwise, the customer is determined to be default, that is:

$$\{ \begin{matrix}{x}_{ij} > {x}_{i}^{c} , & {D}_{j} = 0 \\ {x}_{ij} \leq {x}_{i}^{c} , & {D}_{j} = 1\end{matrix} \qquad ( 2 )$$

Columns 1452-2902 in row 1 of Table 1 are respectively used as the cut-off point xᵢ^{c} of the feature X₁, and the values x₁ⱼ of the feature X₁ in columns 1452-2902 in row 1 of Table 1 are substituted into formula (2) to determine the default statuses of all the customers. The default statuses of all the customers are counted to obtain 1451 sets of values of a, b, c and d which are substituted into formula (1) to obtain 1451 Informedness coefficients corresponding to the feature X₁. The greatest Informedness coefficient is selected as the final Informedness coefficient of the feature X₁. In a similar way, the Informedness coefficients of all features in rows of Table 1 can be obtained, as shown in column e in Table 1.

Step 4: removing the feature which has the Informedness coefficient inᵢ≤0 and cannot identify the default status, and the number of the remaining features becomes M₁.

According to column e of Table 1, four features with nonpositive Informedness coefficient, such as age, are deleted, and marked with “Deleted in Preliminary Screening” in column f of Table 1. The remaining M₁=77 features are renumbered, and the serial numbers are shown in column g of Table 1. The optimal feature subset is selected from the 77 features as follows.

Step 5: introducing the decision variable cᵢ, and giving a weight wᵢ to the credit scoring feature

Adopting the Informedness coefficient inᵢ of the feature to weight the credit scoring feature, and ensuring that the greater the Informedness coefficient is, the larger the weight corresponding to the feature with the stronger default identification ability is, that is:

$${w}_{i} = ( {in}_{i} \times {c}_{i} ) \text{/} {\sum }_{i = 1}^{{M}_{1}} ( {in}_{i} \times {c}_{i} ) \qquad ( 3 )$$

In formula (3), wᵢ is the weight of the i^{th} feature; cᵢ indicates whether the i^{th} feature is selected into the feature system, if yes, cᵢ=1, and if not, cᵢ=0; cᵢ is also the decision variable of the 0-1 programming model of the optimal feature subset; and M₁ is the number of features to be weighted.

The Informedness coefficients inᵢ of the features without the mark of “Deleted in Preliminary Screening” in column e of Table 1 and M₁=77 are substituted into formula (3) to obtain the weights wᵢ corresponding to the 77 features, as shown in formula (3′-1) to formula (3′-77).

$$\{ \begin{matrix}{w}_{1} = \frac{{in}_{1} \times {c}_{1}}{{\sum }_{i = 1}^{77} {in}_{i} \times {c}_{i}} = \frac{0.330 {c}_{1}}{0.330 {c}_{1} + 0.428 {c}_{2} + ⋯ + 0.535 {c}_{77}} & ( {3}^{′} \text{-} 1 ) \\ {w}_{2} = \frac{{in}_{2} \times {c}_{2}}{{\sum }_{i = 1}^{77} {in}_{i} \times {c}_{i}} = \frac{0.428 {c}_{2}}{0.330 {c}_{1} + 0.428 {c}_{2} + ⋯ + 0.535 {c}_{77}} & ( {3}^{′} \text{-} 2 ) \\ … & \\ {w}_{77} = \frac{{in}_{77} - {c}_{77}}{{\sum }_{i = 1}^{77} {in}_{i} \times {c}_{i}} = \frac{0.535 {c}_{77}}{0.330 {c}_{1} + 0.428 {c}_{2} + ⋯ + 0.535 {c}_{77}} & ( {3}^{′} \text{-} 77 )\end{matrix}$$

Step 6: constructing a functional relation between the credit score Sⱼ of the customer and the weight wᵢ of the feature.

Adopting the linear weighting formula to construct the expression of the credit score Sⱼ of the customer, that is:

$${S}_{j} = {\sum }_{i = 1}^{{M}_{1}} {w}_{i} \times {x}_{ij} \qquad ( 4 )$$

In formula (4), wᵢ is the weight of the i^{th} feature, and xᵢⱼ is the value of the j^{th} customer under the i^{th} feature.

Substituting the data xᵢⱼ of features in columns 1452-2902 columns of Table 1 and the feature weights wᵢ of formula (3′-1)-formula (3′-77) into formula (4) to obtain the credit score sⱼ of the j^{th} customer, as shown in formula (4′-1) to formula (4′-1451):

$$\{ \begin{matrix}{s}_{1} = 0.657 \times \frac{0.330 {c}_{1}}{0.330 {c}_{1} + 0.428 {c}_{2} + ⋯ + 0.535 {c}_{77}} + … & ( {4}^{′} \text{-} 1 ) \\ + 0.35 \times \frac{0.535 {c}_{77}}{0.330 {c}_{1} + 0.428 {c}_{2} + ⋯ + 0.535 {c}_{77}} & \\ … & \\ {s}_{1451} = 0.369 \times \frac{0.330 {c}_{1}}{0.330 {c}_{1} + 0.428 {c}_{2} + ⋯ + 0.535 {c}_{77}} + … & ( {4}^{′} \text{-} 1451 ) \\ + 0.569 \times \frac{0.535 {c}_{67}}{0.330 {c}_{1} + 0.428 {c}_{2} + ⋯ + 0.535 {c}_{77}} & \end{matrix}$$

Step 7: constructing the objective function of the 0-1 programming model with the greatest Informedness coefficient IN of the credit score

Replacing the value of the feature in step 3 with the credit score to obtain the Informedness coefficient corresponding to the credit score, and recording as IN. Using the greatest Informedness coefficient IN of the credit score as the objective function, as shown in formula (5):

$$obj \text{:} max IN = \frac{a}{a + b} + \frac{d}{c + d} - 1 \qquad ( 5 )$$

Because in formula (5), the Informedness coefficient IN corresponding to the credit score is obtained according to the comparative analysis of a and b, i.e. according to the comparison of the determined default status Dⱼ and the actual default status Tⱼ of all the customers, i.e. IN=f(Dⱼ,Tⱼ). The comparison of default statuses is obtained according to the relationship between the credit score Sⱼ of the customer and the cut-off point S_{c} of the credit score, i.e. IN=f[g(Sⱼ,S_{c}),Tⱼ], so the Informedness coefficient IN corresponding to the credit score is related to the credit score of the customer.

Also because the credit score Sⱼ of the customer is the linear weighting of the value xᵢⱼ of the feature of the customer and the weight w of the feature, as shown in above formula (4), i.e. IN=f[h(xᵢⱼ,wᵢ),Tⱼ]; the weight wᵢ is also the function of the 0-1 variable cᵢ and the Informedness coefficient inᵢ of the feature, as shown in formula (3), i.e. IN=f{h[xᵢⱼ,q(cᵢ,inᵢ)],Tⱼ}; and therefore the Informedness coefficient IN corresponding to the credit score is the function of the decision variable cᵢ.

If the selected feature is different, that is, cᵢ is different, the weight wᵢ of the feature obtained through step 5 is different, the credit score Sⱼ obtained through step 6 is different, and the Informedness coefficient IN corresponding to the credit score is also different. With the greatest Informedness coefficient IN of the credit score as the objective function and with the decision variable that whether the feature is selected into cᵢ, 0-1 programming is constructed to select one feature subset with the strongest default identification ability as the feature system.

Step 8: constructing the constraint conditions of the 0-1 programming model

Determining the features reflecting information redundancy through rank correlation analysis. If the rank correlation coefficient of a pair of features is greater than or equal to 0.8, the pair of features reflects information redundancy. For each pair of repeated features, an inequality constraint condition is established to ensure that at most only one of a set of features reflecting information redundancy is selected into the final system, as shown in formula (6):

cₖ+cₗ≤1 (6)

wherein cₖ and cₗ are 0-1 variables respectively indicating whether the features k and l are selected into the final feature system. The number of pairs of features reflecting information redundancy is equal to the number of constraint equations (6).

23 pairs of features reflecting information redundancy are obtained through the rank correlation analysis, and the names of features and the rank correlation coefficient of two features are shown in Table 2.

TABLE 2
High Correlation Features

| | | | Rank Correlation |
|---|---|---|---|
| No. | Feature | Feature | Coefficient |
| 1 | Y₁ Asset-Liability Ratio | Y₉ Equity Ratio | 0.997 |
| 2 | Y₂ Net Cash Flow Ratio | Y₈ Cash Recovery | 0.991 |
| | of Current Liabilities | for All Assets | |
| | from Operating | | |
| | Activities | | |
| . . . | . . . | . . . | . . . |
| 23 | Y₇₄ Legal Dispute of | Y₇₅ Number of | 0.811 |
| | Enterprise | Contract Defaults | |
| | | of Enterprise | |

Rows 1-23 of Table 2 are substituted into formula (6), that is:

$$\{ \begin{matrix}{c}_{1} + {c}_{9} \leq 1 & ( {6}^{′} \text{-} 1 ) \\ {c}_{2} + {c}_{8} \leq 1 & ( {6}^{′} \text{-} 2 ) \\ … & \\ {c}_{74} + {c}_{75} \leq 1 & ( {6}^{′} \text{-} 23 )\end{matrix}$$

Several methods are provided to determine features reflecting information redundancy, and one is the rank correlation method.

Step 9: solving the 0-1 programming model and determining the optimal feature subset

With formula (5) as the objective function and formula (6′) as the constraint condition, constructing the 0-1 programming model, and solving the model to obtain the feature subset with the greatest Informedness coefficient IN of the credit score and the corresponding default identification ability of the greatest Informedness coefficient.

The optimal feature subset in credit scoring including 29 features based on the maximum default identification ability of the Informedness coefficient is obtained by the method for determining an optimal feature subset of the present invention with the samples of 1451 small industrial business loans of a commercial bank in China in the past 20 years as an empirical data and marked as “1” in column f of Table 1, and the features not selected are marked as “0”. For the convenience of reading, the features marked as “1” in column f of Table 1 are selected and listed in column 2 of Table 3, and the Informedness coefficient of the feature subset is 0.973.

TABLE 3
Optimal Feature Subset and Comparison Feature Subset Thereof

| | (2) Optimal Feature Subset | (3) Feature Subset Composed of |
|---|---|---|
| (1) | Including 29 Features | First 29 Features with the |
| No. | Established by the Patent | Greatest Informedness Coefficient |
| 1 | Asset-Liability Ratio | Date of Establishing Enterprise |
| 2 | Net Cash Flow Ratio of | Credit Status of Enterprise in the |
| | Current Liabilities from | Past Three Years |
| | Operating Activities | |
| . . . | . . . | . . . |
| 28 | Credit Card Record of | Gross Profit Margin |
| | Legal Representative | |
| 29 | Factor of Mortgage and | Net Cash Flow Ratio of Current |
| | Pledge Guarantee | Liabilities from Operating |
| | | Activities |

Column 3 of Table 3 is the feature subset composed of first 29 features with the greatest Informedness coefficient among all the non-redundant features. The Informedness coefficient of the credit score of the customer based on the feature subset is 0.885, which is significantly less than the Informedness coefficient of 0.973 of the feature subset constructed on the basis of the method of the patent, indicating that the feature subset composed of individual features with strong default identification ability does not necessarily have strong default identification ability.

The present invention still has many embodiments. All the technical solutions formed by adopting equivalent replacement or equivalent transformation of “the method for optimizing a feature subset in credit scoring based on the maximum default identification ability of Informedness coefficient” of the present invention fall within the protection scope of the present invention.

1. An optimal feature subset selection method in credit scoring based on Informedness coefficient, comprising the following steps:
step 1: loading data
loading the data of M₀ initial credit scoring features of N customers and the data of default statuses of the N customers into an Excel file, wherein default=1 and non-default=0;
step 2: preprocessing the data
standardizing the data of the mass-selection credit scoring features to eliminate the influence of feature dimension;
step 3: calculating the default identification ability inᵢ of an individual mass-selection credit scoring feature
measuring the default identification ability of the feature by the Informedness coefficient inᵢ of the feature; the greater the Informedness coefficient of the feature is, the more the actual default customers are determined to be default, and meanwhile, the more the actual non-default customers are determined to be non-default, i.e., the feature has the default identification ability; and the formula of the Informedness coefficient of the feature i is as follows:
$${in}_{i} = \frac{a}{a + b} + \frac{d}{c + d} - 1 \qquad ( 1 )$$
in formula (1), a is the number of customers which are in actual default and are determined to be default; b is the number of customers which are in actual default but are determined to be non-default by mistake; c is the number of customers which are in actual non-default but are determined to be default by mistake; and d is the number of customers which are in actual non-default and are determined to be non-default;
a, b, c and d in formula (1) are obtained through the comparison result of the determined default status Dⱼ and the actual default status Tⱼ; the determined default status is obtained according to the cut-off point xᵢ^{c}; and when the value xᵢⱼ of the feature i of the customer j is greater than the cut-off point xᵢ^{c} of the feature i, the customer is determined to be non-default; otherwise, the customer is determined to be default, that is:
$$\{ \begin{matrix}{x}_{ij} > {x}_{i}^{c} , & {D}_{j} = 0 \\ {x}_{ij} \leq {x}_{i}^{c} , & {D}_{j} = 1\end{matrix} \qquad ( 2 )$$
taking the values of the features i of all the customer respectively as cut-off points to determine the default statuses of all the customers; and setting the cut-off point of the greatest Informedness coefficient inᵢ corresponding to the feature i to the cut-off point of the feature i, and the corresponding greatest Informedness coefficient is the Informedness coefficient of the feature i;
step 4: removing the feature which has the Informedness coefficient inᵢ≤0 and cannot identify the default status, and the number of the remaining features becomes M₁;
step 5: introducing the decision variable cᵢ, and giving a weight wᵢ to the credit scoring feature
adopting the Informedness coefficient in of the feature to weight the credit scoring feature, and ensuring that the greater the Informedness coefficient is, the larger the weight corresponding to the feature with the stronger default identification ability is, that is:
$${w}_{i} = ( {in}_{i} \times {c}_{i} ) \text{/} {\sum }_{i = 1}^{{M}_{1}} ( {in}_{i} \times {c}_{i} ) \qquad ( 3 )$$
in formula (3), wᵢ is the weight of the i^{th} feature; cᵢ indicates whether the i^{th} feature is selected into the feature system, if yes, cᵢ=1, and if not, cᵢ=0; cᵢ is also the decision variable of the 0-1 programming model of the optimal feature subset; and M₁ is the number of features to be weighted;
step 6: constructing a functional relation between the credit score Sⱼ, of the customer and the weight wᵢ of the feature
adopting the linear weighting formula to construct the expression of the credit score Sⱼ of the customer, that is:
$${S}_{j} = {\sum }_{i = 1}^{{M}_{1}} {w}_{i} \times {x}_{ij} \qquad ( 4 )$$
in formula (4), wᵢ is the weight of the i^{th} feature, and xᵢⱼ is the value of the j^{th} customer under the i^{th} feature;
step 7: constructing the objective function of the 0-1 programming model with the greatest Informedness coefficient IN of the credit score
replacing the value of the feature in step 3 with the credit score to obtain the Informedness coefficient corresponding to the credit score, and recording as IN; and using the greatest Informedness coefficient IN of the credit score as the objective function, as shown in formula (5):
$$obj \text{:} max IN = \frac{a}{a + b} + \frac{d}{c + d} - 1 \qquad ( 5 )$$
in formula (5), the Informedness coefficient IN corresponding to the credit score is obtained according to the comparative analysis of a and b, i.e. according to the comparison of the determined default status Dⱼ and the actual default status Tⱼ of all the customers, i.e. IN=f(Dⱼ, Tⱼ); and the comparison of default statuses is obtained according to the relationship between the credit score Sⱼ of the customer and the cut-off point S_{c} of the credit score, i.e. IN=f[g(Sⱼ,S_{c}),Tⱼ], so the Informedness coefficient IN corresponding to the credit score is related to the credit score of the customer;
the credit score Sⱼ of the customer is the linear weighting of the value xᵢⱼ of the feature of the customer and the weight wᵢ of the feature, as shown in formula (4), i.e. IN=f[h(xᵢⱼ,wᵢ),Tⱼ]; the weight wᵢ is also the function of the variable cᵢ of the 0-1 programming model and the Informedness coefficient inᵢ of the feature, as shown in formula (3), i.e. IN=f{h[xᵢⱼ,q(cᵢ,inᵢ)],Tⱼ}; and therefore the Informedness coefficient IN corresponding to the credit score is the function of the decision variable cᵢ;
if the selected feature is different, that is, cᵢ is different, the weight wᵢ of the feature obtained through step 5 is different, the credit score Sⱼ obtained through step 6 is different, and the Informedness coefficient IN corresponding to the credit score is also different; and with the greatest Informedness coefficient IN of the credit score as the objective function and with the decision variable that whether the feature is selected into cᵢ, 0-1 programming is constructed to select one feature subset with the strongest default identification ability as the feature system;
step 8: constructing the constraint conditions of the 0-1 programming model
determining the features reflecting information redundancy through rank correlation analysis; if the rank correlation coefficient of a pair of features is greater than or equal to 0.8, the pair of features reflects information redundancy; and for each pair of repeated features, an inequality constraint condition is established to ensure that at most only one of a set of features reflecting information redundancy is selected into the final system, as shown in formula (6):
cₖ+cₗ≤1 (6)
wherein cₖ and cₗ are 0-1 variables indicating whether the pair of features k and l reflecting information redundancy is selected into the final feature system; and the number of pairs of features reflecting information redundancy is equal to the number of constraint equations (6);
several methods are provided to determine features reflecting information redundancy, and one is the rank correlation method;
step 9: solving the 0-1 programming model and determining the optimal feature subset
with formula (5) as the objective function and formula (6) as the constraint condition, constructing the 0-1 programming model, and solving the model to obtain the feature subset with the greatest Informedness coefficient IN of the credit score and the corresponding default identification ability of the greatest Informedness coefficient.
